(19) United States
(12) Patent Application Publication
(10) Pub. No.: US 2003/0115110 A1
(43) Pub. Date: Jun. 19, 2003

(54) System for managing of underwear having cup portion

(76) Inventors: Hideyuki Yano, Kyoto-shi (JP); Tatsuya Kusakabe, Kyoto-shi (JP); Fujio Katase, Kyoto-shi (JP); Toshiaki Kimura, Kyoto-shi (JP); Saoko Ichikawa, Kyoto-shi (JP)

Correspondence Address: DARBY & DARBY P.C., P. O. BOX 5257, NEW YORK, NY, 10150-5257, US

(21) Appl. No.: 10/148,025

(22) PCT Filed: Jan. 11, 2002
(86) PCT No.: PCT/JP02/00117

(30) Foreign Application Priority Data
Jan. 11, 2001 (JP) 2001-004084

(51) Int. Cl. G06F 17/60

(52) U.S. Cl. 705/26; 705/1

(57) ABSTRACT

Providing a brassiere production management system that enables the efficient production of a brassiere that fits a given user. The brassiere production management system 10 pertaining to the present invention comprises a user information DB 11 that stores information regarding each user's under bust size, the size of the base line of the breast and breast volume, a product information table 12 that stores product identifiers that specify a brassiere that fits a given user's under bust size, the size of the base line of the breast and breast volume, order information input means 21 that inputs order information including a user ID, user information extraction means 22 that extracts from the user information DB 11 user information regarding the user placing the order based on the order information input by the order information input means 21, and product determination means 23 that determines the brassiere to be produced based on the extracted user information and the product information stored in the product information table 12, and outputs the product ID for that brassiere.

### TECHNICAL FIELD

The present invention pertains to a production management system for foundation undergarment having cups, a production management method for foundation undergarment having cups and a recording medium that carry out production management when a foundation undergarment having cups is produced based on an order placed by the user.

### BACKGROUND ART

In general, a foundation undergarment having cups, such as a brassiere, is a ready-made product that is mass-produced through industrial methods, and its size is determined through the combination of the cup size (the difference between the top bust and the circumference of the under bust) and the under bust size. As a result, the key elements of the bust, i.e., the shape and height of the actual bust, are not reflected in the brassiere, and it sometimes occurs that women who share the same brassiere size when using ready-made products will find that a given brassiere may or may not fit when it is worn.

### DISCLOSURE OF THE INVENTION

In order to prevent this problem, a method exists in which the bust size and shape are measured beforehand and the foundation undergarment that fits the individual is made to order, but the steps of measuring the bust size, etc. and designing and producing a foundation undergarment in accordance with the resulting measurements are inefficient and troublesome from a production standpoint.

Accordingly, an object of the present invention is to provide a production management system for foundation undergarment having cups, a production management method for foundation undergarment having cups and a recording medium by which these problems are resolved and a foundation undergarment that fits each individual user can be produced in an efficient manner.

The production management system for foundation undergarment having cups pertaining to the present invention includes user information storage means that stores information regarding user under bust size and the size of the base line of the breast as user information, a product information table that stores product identifiers by which to specify the foundation undergarment that fits a given user's under bust size and the size of the base line of the breast, order information input means that inputs foundation undergarment order information including a user identifier to specify the user placing the order, user information extraction means that extracts from the user information storage means the user information for the user specified via the user identifier included in the order information input using said order information input means, and product determination means that determines based on the user information extracted by said user information extraction means and the product information stored in said product information table the foundation undergarment to be produced, and outputs the product identifier for said foundation undergarment.

Because the production management system for foundation undergarment having cups pertaining to the present invention has user information storage means that stores information regarding the under bust size and the size of the base line of the breast of the user, a foundation undergarment that fits individual users can be produced based on the information stored in the user information storage means. Here, ‘under bust size’ refers to the circumference of the body directly below the bust, and the ‘Size of the base line of the breast’ refers to the contour of the bottom of the bust. Furthermore, because the production management system for foundation undergarment having cups pertaining to the present invention has a product information table that stores product identifiers that specify the foundation undergarment appropriate for a given user's under bust size and the size of the base line of the breast, the product determination means can specify the foundation undergarment to be produced for the user based on the user's under bust size and the size of the base line of the breast. The ‘foundation undergarment having cups’ referred to here may comprise a brassiere, full-length bodice, bra slip, bra camisole, etc.

In the production management system for foundation undergarment having cups described above, it is also acceptable if (i) the user information storage means also stores information regarding user breast volume as user information, and (ii) the product information table stores product identifiers that specify the foundation undergarment that fits a given user's under bust size, the size of the base line of the breast and breast volume.

Because information regarding the user's breast volume is stored in the user information storage means and the product information table stores product identifiers that specify the foundation undergarment that fits a given user's under bust size, the size of the base line of the breast and breast volume as described above, the foundation undergarment appropriate for the user may be more accurately determined. Here, ‘breast volume’ refers to the volume of the bust.

It is also acceptable if the production management system for foundation undergarment having cups described above further includes (i) component information means that stores information regarding the components comprising the foundation undergarment specified via the product identifier, (ii) production instruction sheet preparation means that extracts from the component information table information regarding the components comprising the foundation undergarment specified via the product identifier extracted from the product determination means and prepares a production instruction sheet for such foundation undergarment based on the extracted component information, and (iii) production instruction sheet output means that outputs the production instruction sheet prepared by the production instruction sheet preparation means.

Because information regarding the components comprising each particular foundation undergarment is stored in the component information table as described above, information regarding the components necessary to produce each particular foundation undergarment can be extracted. Furthermore, because an instruction sheet for producing the foundation undergarment is prepared by the production instruction sheet preparation means, production instructions for a foundation undergarment can be easily carried out through delivery or transmission of the prepared production instruction sheet to the production floor.

In the production management system for foundation undergarment having cups described above, it is acceptable if the component information included in the component information table comprises information regarding members, or parts produced from at least one member, that comprise the foundation undergarment.

Storing information on members and parts in the component information table in this way enables uniform management of the members and parts that form the components comprising the foundation undergarment. In the production management system pertaining to the present invention, because production of a foundation undergarment is begun after order information is input, the amount of work carried out on the production floor is not constant, and depends on the number of orders received. By producing parts comprising interim products during a period where there is little input of order information and managing these parts via the component information table, work on the production floor can be evened out, and the production lead time during periods where there are many orders can be shortened. Here, the ‘parts’ comprising the interim products are constituent parts of the foundation undergarments produced from members, such as the cups that come into contact with the bust or the back portions that come into contact with the back when the brassiere is worn. A cup is usually formed in a rounded three-dimensional shape by sewing together two or three pieces of fabric (members). A back portion is prepared by sewing two pieces of fabric to which a pair of mail and female hooks are attached to the back fabric. In addition, ‘members’ include wires, straps, tags, etc.

In the production management system for foundation undergarment having cups described above, it is acceptable if the production instruction sheet preparation means prepares an production instruction sheet that lists component information extracted from the component information table and instructs that these components be assembled.

Listing the components comprising the foundation undergarment as described above enables the personnel on the production floor to easily retrieve the members and parts needed to produce a foundation undergarment of a given size.

In the production management system for foundation undergarment having cups described above, it is furthermore acceptable if (i) such system further includes inventory information storage means that stores inventory information for each component, and (ii) the production instruction sheet preparation means, with reference to the inventory information storage means, includes in the production instruction sheet instructions to produce components that are out of stock.

Including in the production instruction sheet instructions to produce components that are out of stock in this way enables personnel on the production floor to swiftly begin production of components that are no longer in inventory.

In the production management system for foundation undergarment having cups described above, it is acceptable if the production instruction sheet preparation means includes in the production instruction sheet information regarding the user specified via the user identifier included in the order information.

Including in the production instruction sheet information regarding the user who ordered the foundation undergarment as described above (i) enables the delivery destination for the finished foundation undergarment to be checked using the information on the production instruction sheet, and (ii) enables delivery to be swiftly carried out after production of the foundation undergarment.

It is furthermore acceptable if the production management system for foundation undergarment having cups described above further includes (i) an ordering terminal connected to the order information input means over a network, and (ii) the order information is sent from the ordering terminal to the order information input means and input.

Including an ordering terminal connected to the order information input means over a network in this way enables a foundation undergarment to be ordered from a remote location. Where the network is the Internet and the ordering terminal is a personal computer with access to the Internet, the user can conveniently order the foundation undergarment from their home or other location.

The production management method for foundation undergarment having cups pertaining to the present invention has product identifiers for specifying a foundation undergarment that fits a given user's under bust size and the size of the base line of the breast stored beforehand in a product information table, and includes (i) a user information storage step in which information regarding the user's under bust size and the size of the base line of the breast is stored as user information, (ii) an order information input step in which foundation undergarment order information in which foundation undergarment order information including a user identifier to specify the user placing the order is input, (iii) a user information extraction step in which the user information for the user specified via the user identifier included in the order information input in the order information input step is extracted from the user information storage means, and (iv) a product determination step in which the foundation undergarment to be produced is determined based on the user information extracted in the user information extraction step and the product information stored in the product information table, and the product identifier for the foundation undergarment is output.

Because the production management method for foundation undergarment having cups pertaining to the present invention stores information regarding the user's under bust size and the size of the base line of the breast in the user information storage means as described above, a foundation undergarment that fits a given user can be produced based on the information stored in the user information storage means. In addition, because the production management method for foundation undergarment having cups pertaining to the present invention stores in a product information table product identifiers that specify the foundation undergarment that fits a given user's under bust size and the size of the base line of the breast, the foundation undergarment to be produced for that user can be determined in the product determination step based on the user's under bust size and the size of the base line of the breast.

In the production management method for foundation undergarment having cups described above, it is acceptable if (i) product identifiers specifying the foundation undergarment that fits a given user's under bust size, the size of the base line of the breast and breast volume are stored in the product information table, and (ii) in the user information storage step, information regarding the user's breast volume is also stored as user information.

Because information on the user's breast volume is stored in the user information storage means and the product information table stores product identifiers that specify the foundation undergarment that fits a given user's under bust size, the size of the base line of the breast and breast volume as described above, a foundation undergarment that fits the user can be determined more precisely in the product determination step.

It is acceptable if the production management method for foundation undergarment having cups described above has information regarding the components comprising the foundation undergarment identified by the product identifier stored beforehand in a component information table and further includes (i) a production instruction sheet preparation step in which (a) information regarding the components comprising the foundation undergarment specified by the product identifier output in the product determination step is extracted from the component information table, and (b) a production instruction sheet is prepared for the foundation undergarment based on the extracted component information, and (ii) a production instruction sheet output step in which the production instruction sheet prepared in the production instruction sheet preparation step is output.

Because information regarding the components comprising a given foundation undergarment is stored in a component information table as described above, information on components necessary to produce a given foundation garment can be extracted in the production instruction sheet preparation step. Moreover, because an instruction sheet used for production of a foundation undergarment is prepared in the production instruction sheet preparation step, production instructions for the foundation undergarment can be easily carried out through delivery or transmission of the prepared production instruction sheet to the production floor.

In the production management method for foundation undergarment having cups described above, it is furthermore acceptable if the component information included in the component information table comprises information regarding members, and parts produced from at least one member, that comprise the foundation undergarment.

Storing information regarding members and parts in the component information table as described above enables the members and parts that comprise the components of the foundation undergarment to be managed in a uniform fashion. In the production management method of the present invention, because production of a foundation undergarment is begun after order information is input, the amount of work carried out on the production floor is not constant, and depends on the number of orders received. By producing parts comprising interim products during a period where there is little input of order information and managing these parts via the component information table, work on the production floor can be evened out, and the production lead time during periods where there are many orders can be shortened.

In the production management method for foundation undergarment having cups described above, it is acceptable if the production instruction sheet preparation step prepares a production instruction sheet that lists the component information extracted from the component information table and instructs that the components be assembled.

Listing the components comprising the foundation undergarment in this fashion enables the employees of the production floor to easily retrieve the members and parts needed to produce the foundation undergarment of a given size.

In the production management method for foundation undergarment having cups described above, it is acceptable if (i) inventory information for each component is stored beforehand in an inventory information storage means, and (ii) in said production instruction sheet preparation step, instructions to produce components that are out of stock are included in the production instruction sheet via said inventory information storage means.

Including in the production instruction sheet production instructions to produce components that are out of stock enables personnel on the production floor to swiftly begin production of components that are no longer in inventory.

In the production management method for foundation undergarment having cups described above, it is furthermore acceptable if, in the production instruction sheet preparation step, information regarding the user specified via user identifier included in the order information is included in the production instruction sheet.

Including in the production instruction sheet information regarding the user who ordered the foundation undergarment as described above (i) enables the delivery destination for the finished foundation undergarment to be checked using the information on the production instruction sheet, and (ii) enables delivery to be swiftly carried out after production of the foundation undergarment.

In order to manage the production of foundation undergarments having cups, the computer-readable recording medium pertaining to the present invention stores a program that causes the computer to function as user information storage means that stores information regarding user under bust size and the size of the base line of the breast as user information, product information storage means that stores product identification information including product identifiers that are used to specify the foundation undergarment that fits a given user's under bust size and the size of the base line of the breast, order information input means that inputs foundation undergarment order information including a user identifier to specify the user placing the order, user information extraction means that extracts from the user information storage means the user information for the user specified via the user identifier included in the order information input using the order information input means, and product determination means that determines based on the user information extracted by the user information extraction means and the product information stored in the product information table the foundation undergarment to be produced, and outputs the product identifier for the foundation undergarment.

By having the computer read the recording medium pertaining to the present invention and execute the program in this fashion, the computer can be utilized as user information storage means that stores information regarding user under bust size and the size of the base line of the breast, and a foundation undergarment that fits a given user can be produced based on information stored in the user information storage means. In addition, by having the computer read the recording medium pertaining to the present invention and execute the program in this fashion, product identifiers that are used to specify the foundation undergarment that fits a given user's under bust size and the size of the base line of the breast can be stored in the computer, and the foundation undergarment to be produced for a given user can be specified based on the user's under bust size and the size of the base line of the breast.

### BRIEF DESCRIPTION OF THE DRAWINGS

FIG. 1 is a block diagram showing the construction of a brassiere production management system.

FIG. 2 is a drawing showing an example of the data stored in a user information database.

FIG. 3 is a drawing showing an example of the data stored in a product information table.

FIG. 4 is drawing showing an example of the data stored in a component information table.

FIG. 5A is a drawing showing an example of the cup data stored in an inventory information table, while FIG. 5B is a drawing showing an example of the hook data stored in an inventory information table.

FIG. 6 is a flow chart showing the operation of a brassiere production management system.

FIGS. 7A and 7B are drawings showing examples of an output production instruction sheet.

FIG. 8 is a construction drawing of the recording medium 60 pertaining to an embodiment of the present invention.

FIG. 9 is a system construction drawing of the computer used to run the undergarment production management program stored in the recording medium.

FIG. 10 is a perspective view of the computer used to run the undergarment production management program stored in the recording medium.

### BEST MODES FOR CARRYING OUT THE INVENTION

A preferred embodiment of the production management system for foundation undergarment having cups pertaining to the present invention will now be explained in detail with reference to the drawings. In this embodiment, a brassiere is used as an example of the foundation undergarment having cups, and a brassiere production management system will be explained. Furthermore, in regard to the drawings, identical reference symbols are used for identical elements, and explanations of such elements will not be duplicated.

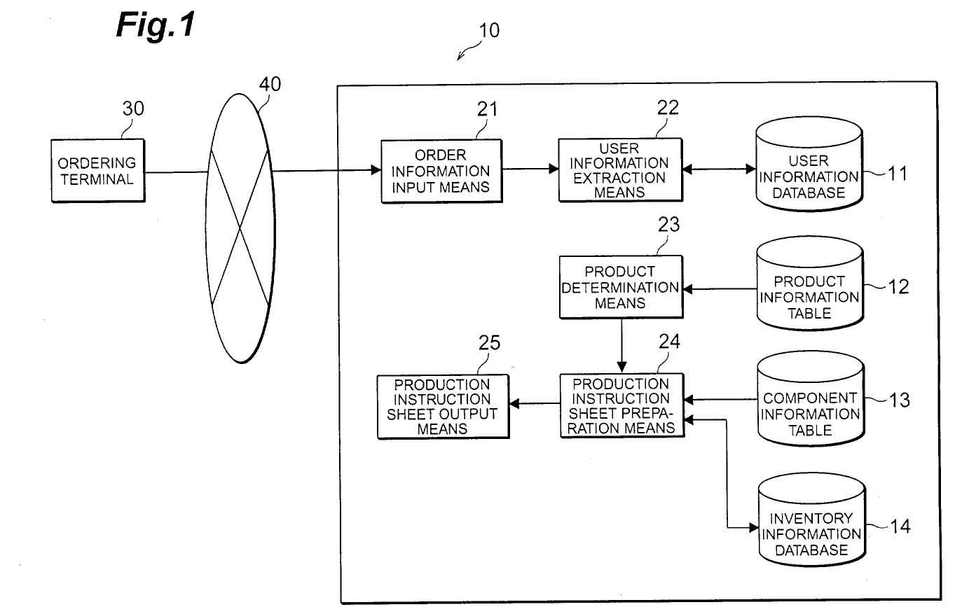

FIG. 1 is a block diagram showing the construction of a brassiere production management system 10 pertaining to this embodiment. The brassiere production management system 10 includes a user information database (hereinafter ‘user information DB’) 11 that stores information regarding each user's bust, a product information table 12 that stores product identifiers for a brassiere that fits a given user's under bust size, the size of the base line of the breast and breast volume, a component information table 13 that stores information on the components that may be used to form each individual brassiere, and an inventory information database (hereinafter ‘inventory information DB’) 14 that stores inventory information on the various components. The brassiere production management system 10 further includes order information input means 21 that inputs order information, user information extraction means 22 that extracts from the user information DB 11 user information regarding the user placing the order, product determination means 23 that determines the brassiere that will fit the user based on the extracted user information, production instruction sheet preparation means 24 that prepares a production instruction sheet for use in producing the determined brassiere, and production instruction sheet output means 25 that outputs the prepared production instruction sheet. In addition, an ordering terminal 30 is connected to the order information input means 21 via a network 40.

The various elements comprising the brassiere production management system 10 will now be explained in sequence.

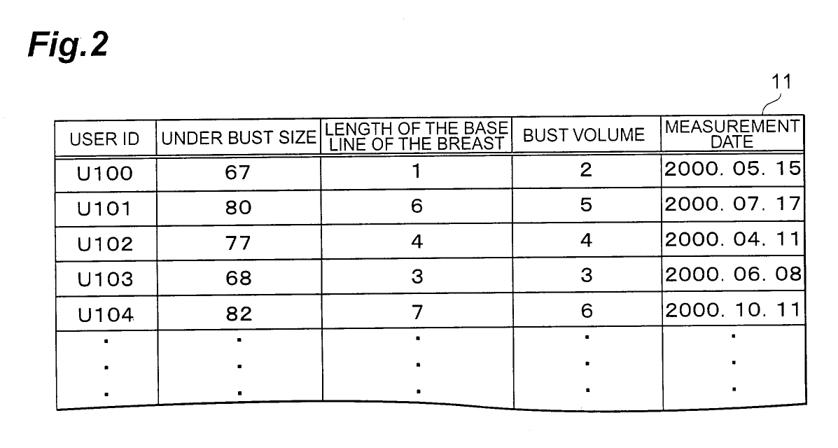

The user information DB 11 is a database that stores information regarding each user's under bust size, the size of the base line of the breast line of the breast and breast volume. FIG. 2 is a drawing showing an example of data stored in the user information DB 11. As shown in FIG. 2, information items entitled ‘User ID’, ‘Under Bust Size’, ‘Size of the base line of the breast’, ‘Breast volume’ and ‘Measurement Date’ are stored in the user information DB 11. The ‘User ID’ is an identifier used to specify a user. ‘Under Bust Size’, ‘Size of the base line of the breast’ and ‘Breast volume’ are items of information pertaining to the bust of the user specified via the user ID. These information items are measured and stored beforehand. The size of the base line of the breast and the breast volume are not values that are actually measured. Instead, a range in which measurements may exist is divided into multiple ranges, and the size of the base line of the breast and the breast volume are expressed in terms of the number assigned to the range that includes the actual measurement. In this embodiment, the size of the base line of the breast are divided into the ten ranges of 0 through 9, and breast volume are divided into the eight ranges of 1 through 8. The ‘Measurement Date’ is information regarding the date on which the ‘Under Bust Size’, ‘Size of the base line of the breast’ and ‘Breast volume’ were measured. Because these items of information such as ‘Under Bust Size’ or ‘Size of the base line of the breast’ comprise information regarding the body, they are not immutable and can change over a period of months or years, and therefore the date of measurement is stored. In this embodiment, the body information measured on the measurement date is stored in the user information DB 11, but it is also acceptable if the history of such information, which changes over time, is stored therein. Because the amount of data in the user information DB 11 increases as the body measurement information continues to be stored therein as history data, it is acceptable if the history data is stored and archived in a different recording medium. In this embodiment, only information regarding the user's bust is stored in the user information DB 11, but it is acceptable if information regarding user attributes such as the user's name, age, date of birth, address, history of purchase of undergarment, etc., is stored therein as well. Alternatively, it is acceptable if information regarding these user attributes and the history of purchase is stored in a separate database.

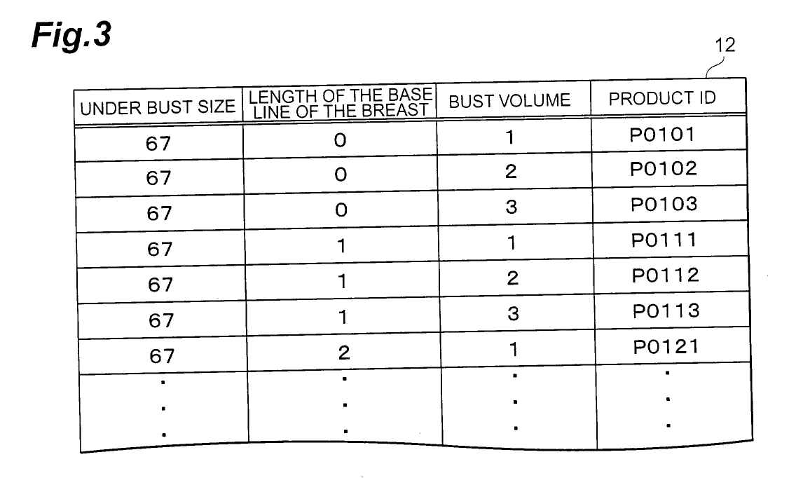

The product information table 12 is a table in which are stored product identifiers that are associated with a combination of values for under bust size, the size of the base line of the breast and breast volume for a brassiere that fits a particular user. FIG. 3 is a drawing showing an example of the data stored in the product information table 12. Stored in the product information table 12 is information regarding ‘Under Bust Size’, ‘Size of the base line of the breast’, ‘Breast volume’ and ‘Product ID’. ‘Product ID’ is an identifier that specifies a particular brassiere. In the product information table 12 of this embodiment, combinations of under bust size, the size of the base line of the breast and breast volume that are unlikely to exist in the real world are not listed. For example, because women with an under bust size of 67 cm and the size of the base line of the breast of 2 are statistically unlikely to have a breast volume greater then 6, combinations of an under bust size of 67 cm, the size of the base line of the breast of 2 and a breast volume greater then 6 are not listed. Listing only combinations that are realistically likely to exist helps limit the number of products to the number actually necessary.

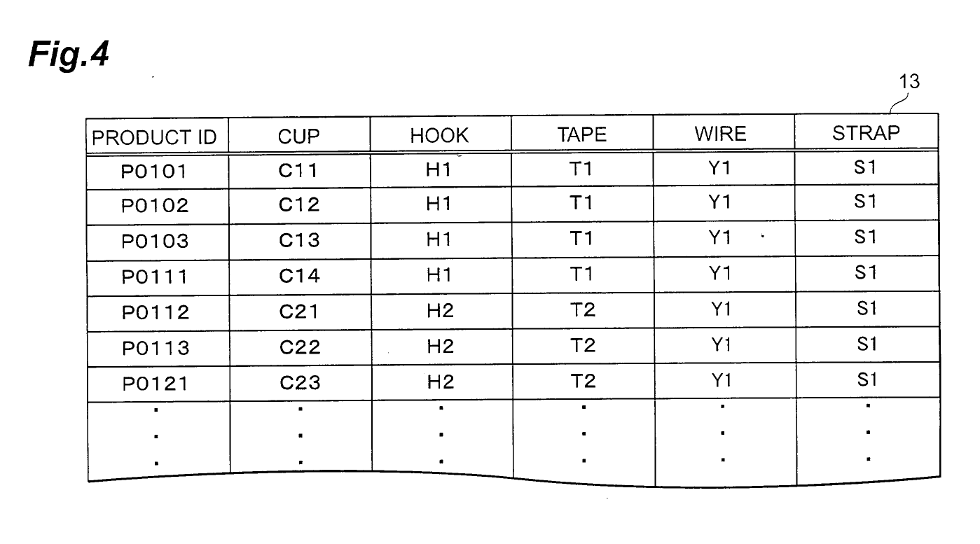

The component information table 13 is a table that stores information regarding the components that comprise the various types of brassieres. FIG. 4 is a drawing showing an example of the data stored in the component information table 13. Stored in the component information table 13 is information regarding ‘Product ID’, ‘Cup’, ‘Hook’, ‘Tape’, ‘Wire’ and ‘Strap’. ‘Product ID’ is an information item specifying the type of brassiere. ‘Cup’, ‘Hook’ and ‘Tape’ are information items identifying parts used in the brassiere, while ‘Wire’ and ‘Strap’ are information items identifying members used in the brassiere. For example, it is seen that the brassiere with product ID ‘P0101’ is composed from the parts respectively identified as cup ‘C11’, hook ‘H1’ and tape ‘T1’, and the members respectively identified as wire ‘Y1’ and strap ‘S1’. In the component information table 13 of this embodiment, information regarding cups, hooks, tapes, etc. is stored as brassiere component information, but information regarding ribbons, beads, etc. may be stored as well.

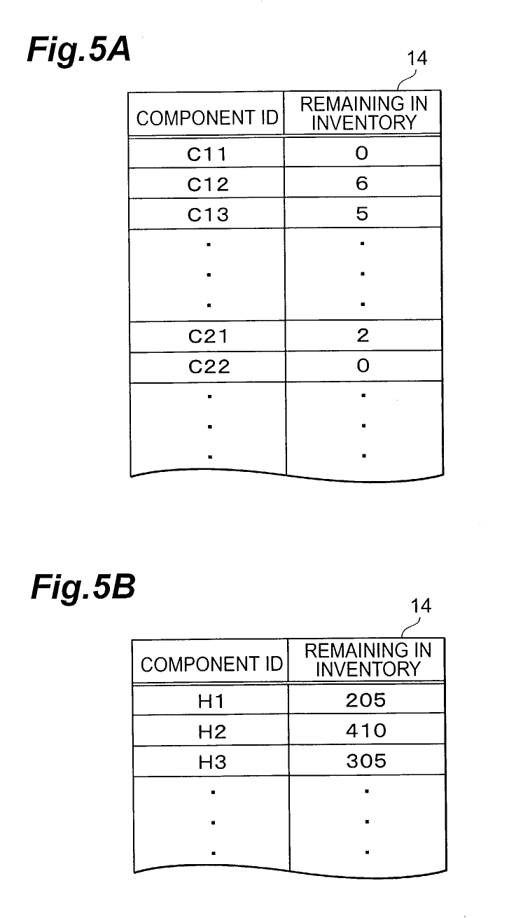

The inventory information DB 14 is a database that stores information regarding the inventory status of the components. FIGS. 5A and 5B are drawings showing examples of the data stored in the inventory information DB 14. FIG. 5A shows the inventory information regarding cups, and FIG. 5B shows the inventory information regarding hooks. As shown in FIGS. 5A and 5B, information regarding ‘Component ID’ and ‘Inventory’ is stored in the inventory information DB 14. ‘Component ID’ is an identifier that specifies a component, and ‘Inventory’ comprises information indicating the number of units of the component specified via the component ID remaining in inventory. Referring to FIGS. 5A and 5B, it is seen that while there are fewer cups in inventory than hooks, this is due to the difference between the two components in terms of the brassieres in which they may be used, i.e., the fact that although the use of a particular cup is closely related to the size of the brassiere, hooks are used in virtually all brassiere sizes.

The order information input means 21 has the function of inputting brassiere order information. Where the order information input means 21 is connected to the ordering terminal 30 via the network 40, as in this embodiment, it also has the function of a receiving means that receives order information sent from the ordering terminal 30. The order information input via the order information input means 21 includes information regarding the user ID of the user placing the order, as well as the color and design (specified via the product number) of the desired brassiere.

The user information extraction means 22 has the function of extracting from the user information DB 11 user information based on the user ID included in the order information input via the order information input means 21.

The product determination means 23 has the function of (i) determining the brassiere that fits the user placing the order based on the user information extracted via the user information extraction means 22 and (ii) outputting the product ID of that brassiere. Specifically, based on the under bust size, the size of the base line of the breast and breast volume extracted as user information via the user information extraction means 22, the product ID for the brassiere corresponding to that combination of sizes is extracted from the product information table 12.

The production instruction sheet preparation means 24 has the function of preparing a production instruction sheet for producing a brassiere based on the product ID determined and subsequently output by the product determination means 23. The production instruction sheet preparation means 24 extracts from the component information table 13 the information on the components that may be used to prepare the brassiere and determines whether the extracted components exist in inventory. Where the extracted components do exist in inventory, the production instruction sheet preparation means 24 lists the components and issues assembly instructions for the brassiere, while if some (or all) of the components do not exist in inventory, the production instruction sheet preparation means 24 issues an instruction for the production of the absent components, lists the components existing in inventory and issues assembly instructions for the brassiere.

The production instruction sheet output means 25 has the function of outputting the production instruction sheet prepared by the production instruction sheet preparation means 24. More specifically, the production instruction sheet output means 25 prints out the production instruction sheet on a sheet of paper. Alternatively, it is acceptable if the production instruction sheet output means 25 sends the data contained in the production instruction sheet to a terminal located on the brassiere production floor and the production instruction sheet is output via that terminal.

The operation of the brassiere production management system 10 pertaining to this embodiment will now be explained, and furthermore, the production management method for foundation undergarment having cups pertaining to the present invention will be explained using brassiere production management as an example.

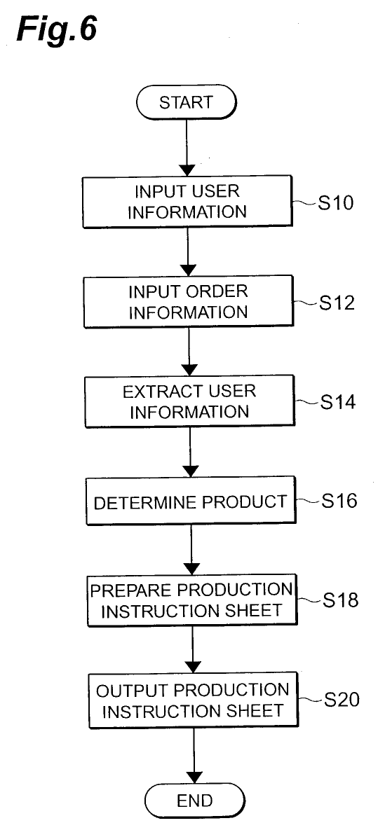

FIG. 6 is a flow chart showing the operation of the brassiere production management system 10. First, user information is input to the user information DB 11 of the brassiere production management system 10 (S10). While the under bust size can be measured using a regular tape measure, because the size of the base line of the breast and the breast volume must be measured using a dedicated measuring instrument, the user travels to a measuring floor provided by the operator of the brassiere production management system to be measured. The measured under bust size, the size of the base line of the breast and breast volume are stored as user information in the user information DB 11. Step S10 is a preparatory stage for operation of the brassiere production management system. In addition, only the user whose user information was input in step S10 can input brassiere order information in the brassiere production management system 10 in accordance with the operation described below in order to have a brassiere produced.

The brassiere purchasing stage will now be explained. First, the order information for the brassiere is input (S12). The order information includes the product number and the color of the brassiere that the user wishes to buy, as well as the user ID that specifies the user placing the order. The ‘product number’ is a number used to specify a type of brassiere listed in a catalog or the like. The input of the order information may be carried out by an operator in accordance with information contained in an order form sent in by the user, or the input may be carried out by transmitting the order information from the ordering terminal 30 to the order information input means 21 via the network 40.

When the order information is input via the order information input means 21 (S12), the user information extraction means 22 extracts from the user information DB 11 the user information regarding the user placing the order, based on the user ID included in the input order information (S14). As a specific example, when the order information for the user having the user ID ‘U100’ is input, the user information extracted as user information consists of information that the user's under bust size is 67 cm, with the size of the base line of the breast of 1 and a breast volume of 2 (See FIG. 2).

Next, the product determination means 23 determines the brassiere that fits the specified user based on the user information extracted by the user information extraction means 22, and outputs the product number for the brassiere (S16). In the specific example described above, with reference to the product information table 12 shown in FIG. 3, the brassiere that fits the user having the user ID ‘U100’ is determined to have a product ID of ‘P0112’. The product ID is different from the product number included in the order information. While the product number describes the type of the of the brassiere, i.e., the configuration, design and the like, the product ID describes the size, cup configuration, etc., of the same brassiere.

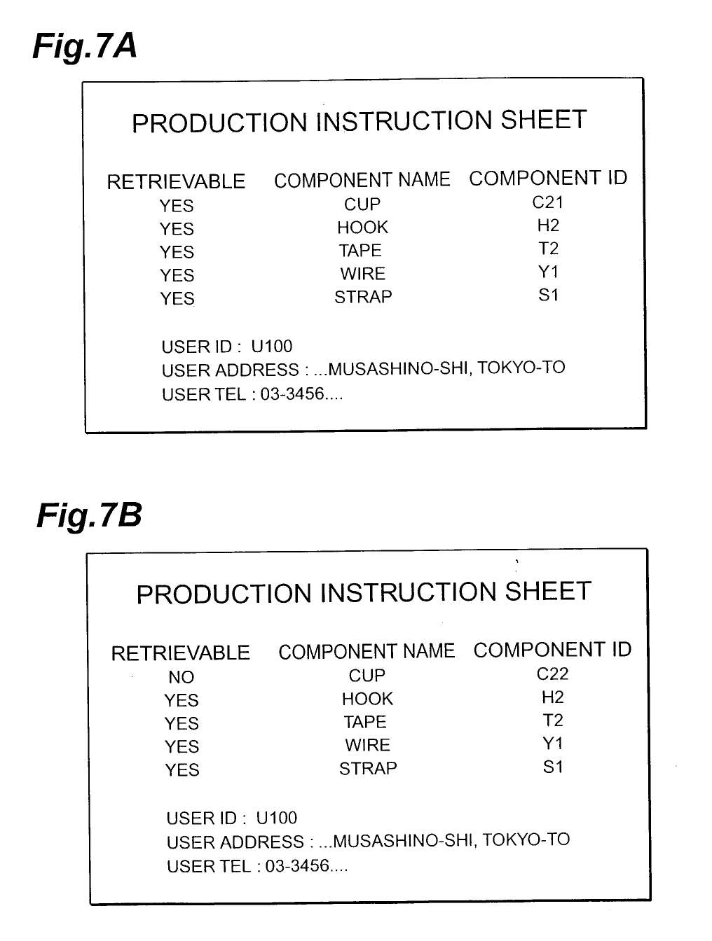

The production instruction sheet preparation means 24 then prepares a production instruction sheet used to produce the brassiere specified via the determined product ID (S18). First, the production instruction sheet preparation means 24 extracts information on the components comprising the brassiere pertaining to the determined product ID from the component information table 13. Here, with regard to the component IDs for the components comprising the brassiere having the product ID ‘P0112’, information that the cups have a component ID of ‘C21’, the hooks have a component ID of ‘H2’, the tape has a component ID of ‘T2’, the wires have a product ID of ‘Y1’ and the straps have a product ID of ‘S1’ is extracted (see FIG. 4). The production instruction sheet preparation means 24 then determines, with reference to the inventory information DB 14, whether or not the extracted components exist in inventory. Because there are two cups specified by the component ID ‘C21’ in inventory according to the inventory information DB 14 shown in FIG. 5A, and 410 hooks specified by the component ID ‘H2’ in inventory according to the inventory information DB 14 shown in FIG. 5B, it is seen that both of the components exist in inventory. Tape, wires and straps are also found to exist in inventory, though this is not shown in the database example shown. Because the components in inventory are retrieved to produce the brassiere, the number of components stored in the inventory information DB 14 is reduced by the number of components used to prepare the brassier. Because all of the components that are needed to prepare the brassiere pertaining to the product ID ‘P0112’ exist in inventory as described above, the production instruction sheet preparation means 24 prepares a production instruction sheet for the brassiere in which these components are listed. The production instruction sheet output means 25 then outputs the prepared production instruction sheet (S20). FIG. 7A is a drawing showing an example of the output production instruction sheet. As shown therein, the production instruction sheet contains information specifying components used to prepare a brassiere. Here, ‘Retrievable’ comprises information indicating whether or not the component specified via the listed component ID can be retrieved from inventory, i.e., whether or not it exists in inventory. Because all of the components exist in inventory in the specific example described above, the value for all components under ‘Retrievable’ is ‘Yes’, as shown in FIG. 7A. Where a cup is the component specified via the component ID ‘C22’, the component does not exist in inventory (see FIG. 5A), and therefore the value for ‘Retrievable’ is ‘No’, as shown in FIG. 7B. Because the fact that the ‘Retrievable’ value is ‘No’ means that the component does not exist in inventory, it means that a production instruction is issued for that component. The production instruction sheet also includes the name, address and telephone number of the user ordering the brassiere. Because the user's name, address and other information are included in this fashion, the brassiere produced (assembled) in accordance with the instruction sheet can be delivered swiftly to the address written on the production instruction sheet.

One way in which to use the production instruction sheet will now be explained. After it is output, the production instruction sheet is either delivered to the brassiere production floor or output on the production floor. On the production floor, an employee places each sheet on a separate dedicated tray. The employee then retrieves the components listed on the production instruction sheet from the stockroom and places them on the tray. In this way, the components are collected on the tray and a set of components to be used to produce the brassiere can be assembled. The component sets collected on the trays are then fed one tray at a time to an sewing line, and each brassiere is finished on the sewing line. The finished brassiere is then shipped to the address of the user listed on the production instruction sheet. Use of a production instruction sheet in this manner enables smooth production and shipping of a brassiere using the production instruction sheet shown in FIG. 7A.

The brassiere production management system 10 pertaining to the present invention has a user information DB 11 that stores information regarding the user's under bust size, the size of the base line of the breast and breast volume. Use of this information enables a brassiere that fits the user to be produced when the user orders a brassiere.

Furthermore, because the brassiere production management system 10 has a product information table 12 that stores information on each brassiere that fits a given combination of under bust size, the size of the base line of the breast and breast volume, the product determination means 23 can swiftly determine the brassiere that fits the user based on the user information.

Furthermore, because the brassiere production management system 10 has a component information table 13 that stores information on the components that may be used to prepare a brassiere, the production instruction sheet preparation means 24 can extract information regarding the components needed to produce the brassiere and prepare a production instruction sheet. In addition, because the brassiere production management system 10 has an inventory information DB 14 that contains the inventory information for each component, it can be indicated on the production instruction sheet whether each component needs to be produced, or whether it can be retrieved from inventory. While there are numerous types of brassiere components, if the production management system possesses information regarding inventory as described in connection with this embodiment, it is no longer difficult and troublesome to determine whether or not the required components are present from among these numerous components. Accordingly, because components not existing in inventory are produced immediately, the efficiency of brassiere production is improved.

Furthermore, because the brassiere production management method pertaining to this embodiment stores beforehand in the user information DB 11 user information pertaining to the user's under bust size, the size of the base line of the breast and breast volume, a brassiere that fits each user can be produced based on the stored user information.

In addition, the brassiere production management method, like the brassiere production management system 10 described above, has the effect of improving brassiere production efficiency.

Finally, the computer-readable recording medium (hereinafter referred to simply as the ‘recording medium’) pertaining to the present invention will now be described. As referred to herein, the recording medium can, in accordance with the content of the program, bring about a change in magnetic, optical, electric or other energy with regard to a reading apparatus included among the hardware resources of the computer, thereby transmitting the content of the program to the reading apparatus in a compatible signal format. The recording medium may comprise a magnetic disk, an optical disk, a CD-ROM, a memory built into the computer, or similar means.

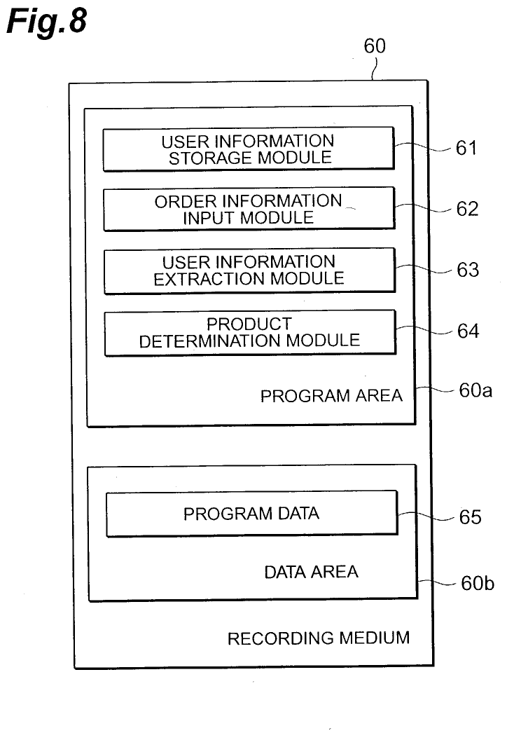

FIG. 8 is a construction drawing of the recording medium 60 pertaining to an embodiment of the present invention. The recording medium 60 stores an undergarment production management program, and includes a program area 60a that stores the program and a data area 60b, as shown in FIG. 8. Product data 65 that includes product identifiers used to specify the foundation undergarment that fits a given user's under bust size and the size of the base line of the breast is stored in the data area 60b. Stored in the program area 60a are a user information storage module 61 that causes the computer to store user information, an order information input module 62 that allows undergarment order information to be input, a user information extraction module 63 that causes the computer to extract user information based on the user identifier included in the input order information, and a product determination module 64 that determines a product based on the extracted user information and the product data 65 stored in the data area 60b. Here, by executing the user information storage module 61 via the computer, a database similar to the user information DB11 of the brassiere production management system 10 described above can be constructed in the computer. Furthermore, the functions realized by executing the order information input module 62, the user information extraction module 63 and the product determination module 64 are identical to the functions of the order information input means 21, the user information extraction means 22 and the product determination means 23 of the brassiere production management system 10 described above, respectively. In addition, the product data 65 stored in the data area 60b is equivalent to the product information table 12 of the brassiere production management system 10 described above.

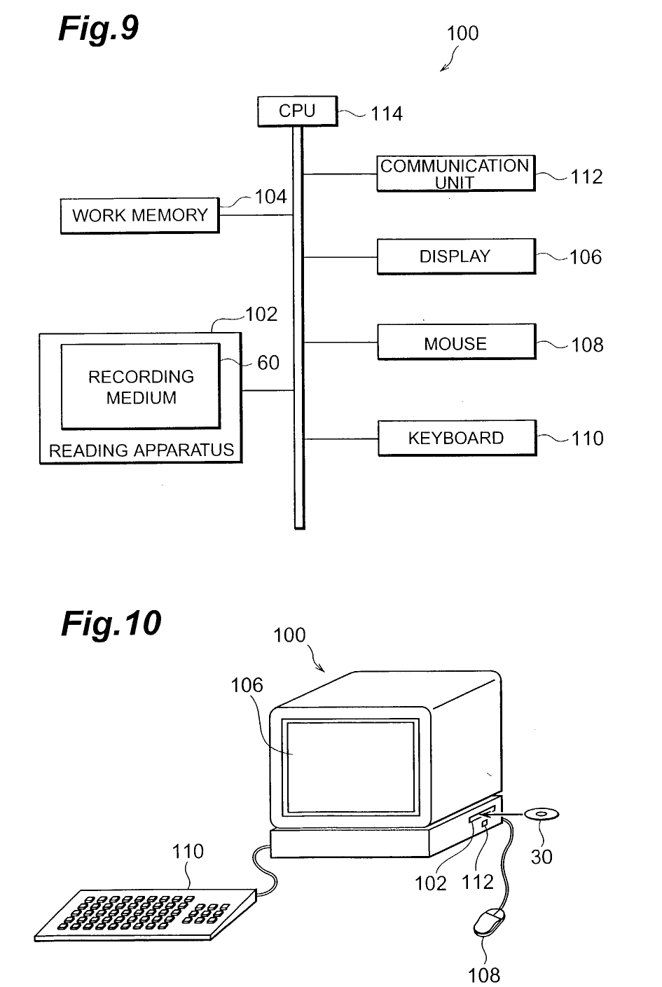

FIG. 9 is a system construction drawing of the computer (such as the server system) used to run the undergarment production management program stored in the) recording medium 60, and FIG. 10 is a perspective view of the computer used to run the undergarment production management program stored in the recording medium 60. As shown in FIGS. 9 and 10, the computer 100 includes a reading apparatus 102, a work memory (RAM) 104 in which the operating system (OS) permanently resides, a display 106 comprising display means, a mouse 108 and keyboard 110 comprising input means, a communication unit 112 comprising communication means, and a CPU 114 that controls such things as the running of the undergarment production management program. When the recording medium 60 is inserted in the reading apparatus 102, the information recorded in the recording medium 60 can be accessed by the reading apparatus 102, and the undergarment production management program recorded in the program area 60 of the recording medium 60 can be run by the computer 100.

For the reading apparatus 102 described above, a floppy disk drive device, CD-ROM drive device, magnetic tape drive device or other device may be used in accordance with the type of recording medium 60.

By having the computer read the recording medium pertaining to the present invention and execute the program stored therein, the production of brassieres (undergarments) that fit any given user can be managed in the same way as in the brassiere production management system 10 described above.

While an embodiment of the present invention was described in detail above, the present invention is not limited to the above embodiment.

While in the above embodiment the brassiere production management system 10 has an ordering terminal 30, an ordering terminal 30 is not essential, and the brassiere production management system 10 may have a construction in which it is not connected to the network 40.

While in the above embodiment information on the user's breast volume is stored in the user information DB 11 and the product information table 12 stores information regarding brassieres that will fit a given user's under bust size, the size of the base line of the breast and breast volume, breast volume information is not essential. In other words, it is acceptable if only the under bust size and the size of the base line of the breast are stored as user information and information regarding brassieres that will fit a given user's under bust size and the size of the base line of the breast only is stored in the product information table 12. This would enable the brassiere production management system 10 to be realized using a simpler construction.

While in the above embodiment, where a component not existing in inventory is required, an instruction to produce that component is included in the production instruction sheet, it is acceptable if, the production management system 10 includes out-of-stock inventory output means that outputs a list of components that are out of stock beforehand where there are components that are out of stock. Including out-of-stock inventory output means in this manner would enable the number of occurrences of an out-of-stock situation to be reduced, thereby increasing brassiere production efficiency. It is furthermore preferred that the out-of-stock inventory output means change the standard for determining whether an inventory item is out of stock in accordance with the type of inventory item. For example, for components such as hooks that can be used in a number of different types of brassieres, it is important that a reasonable amount of inventory be maintained as a margin, while in the case of components that vary in size and configuration depending on the user, such as cups, not only it is not necessary that a large inventory be maintained for each type, but there is also a danger of accumulation of excessive inventory.

Moreover, because a person's body shape changes over time, it is acceptable if the brassiere production management system 10 further includes re-measurement notification means that, based on the date information contained in the user information DB 11, recommends after a prescribed period of time has elapsed since the date of measurement to the user that she perform re-measurement. Recommending re-measurement via the re-measurement notification means and updating the user's user information enables the brassiere production management system 10 to supply a brassiere that fits the user better.

### INDUSTRIAL APPLICABILITY

Because the present invention has user information storage means that stores information regarding the user under bust size and the size of the base line of the breast, a brassiere appropriate for a given user can be produced based on the information stored in the user information storage means.

Furthermore, because the present invention has a product information table that stores product identifiers that specify the brassiere that fits a given user's under bust size and the size of the base line of the breast, the product determination means can determine the brassiere to be produced for that user based on the user's under bust size and the size of the base line of the breast.

1. A production management system for foundation undergarment having cups, wherein said system comprises:
user information storage means that stores information regarding user under bust size and the size of the base line of the breast as user information;
a product information table that stores product identifiers to specify the foundation undergarment that fits a given user's under bust size and the size of the base line of the breast;
order information input means that inputs foundation undergarment order information including a user identifier to specify the user placing the order;
user information extraction means that extracts from the user information storage means the user information for the user specified via the user identifier included in the order information input by said order information input means; and
product determination means that determines based on the user information extracted by said user information extraction means and the product information stored in said product information table the foundation undergarment to be produced, and outputs the product identifier for said foundation undergarment.

2. The production management system for foundation undergarment having cups according to claim 1, wherein:
information regarding user breast volume is also stored in said user information storage means as user information; and
product identifiers that specify the foundation undergarment that fits a given user's under bust size, the size of the base line of the breast and breast volume are stored in said product information table.

3. The production management system for foundation undergarment having cups according to claim 1 or claim 2, wherein said system further comprises:
a component information table that stores information regarding the components that constitute the foundation undergarment specified via said product identifier;
production instruction sheet preparation means that extracts from the component information table information regarding the components constituting the foundation undergarment specified via the product identifier output by said product determination means and prepares a production instruction sheet for such foundation undergarment based on the extracted component information; and
production instruction sheet output means that outputs the production instruction sheet prepared by said production instruction sheet preparation means.

4. The production management system for foundation undergarment having cups according to claim 3, wherein the component information included in said component information table consists of information regarding members, and parts produced from at least one member, that constitute the foundation undergarment.

5. The production management system for foundation undergarment having cups according to claim 3 or claim 4, wherein said production instruction sheet preparation means prepares a production instruction sheet that lists information on the components extracted from said component information table and instructs that said components be assembled.

6. The production management system for foundation undergarment having cups according to any of claims 3 through 5, wherein said system further comprises inventory information storage means that stores inventory information regarding each of said components, and wherein said production instruction sheet preparation means, with reference to said inventory information storage means, includes in the production instruction sheet instructions to produce components that are out of stock.

7. The production management system for foundation undergarment having cups according to any of claims 3 through 6, wherein said production instruction sheet preparation means includes in the production instruction sheet information regarding the user specified via the user identifier included in the order information.

8. The production management system for foundation undergarment having cups according to any of claims 1 through 7, wherein said system further comprises an ordering terminal that is connected to said order information input means over a network, and wherein said order information is sent and input from said ordering terminal to said order information input means.

9. A production management method for foundation undergarment having cups, wherein product identifiers to specify a foundation undergarment that fits a given user's under bust size and the size of the base line of the breast are stored beforehand in a product information table, and wherein said method comprises:
a user information storage step in which information regarding the user's under bust size and the size of the base line of the breast is stored in user information storage means as user information;
an order information input step in which foundation undergarment order information including a user identifier to specify the user placing the order is input;
a user information extraction step in which the user information for the user specified via the user identifier included in the order information input in said order information input step is extracted from the user information storage means; and
a product determination step in which the foundation undergarment to be produced is determined based on the user information extracted in said user information extraction step and the product information stored in said product information table, and the product identifier for said foundation undergarment is output.

10. The production management method for foundation undergarment having cups according to claim 9, wherein:
product identifiers to specify the foundation undergarment that fits a given user's under bust size, the size of the base line of the breast and breast volume are stored beforehand in said product information table; and
in said user information storage step, information regarding the user's breast volume is further stored as user information.

11. The production management method for foundation undergarment having cups according to claim 9 or claim 10, wherein information regarding components constituting the foundation undergarment specified via said product identifier is stored beforehand in said component information table, and wherein said method further comprises:
a production instruction sheet preparation step in which information regarding the components constituting the foundation undergarment specified via the product identifier extracted in said product determination step is extracted from the component information table, and a production instruction sheet for such foundation undergarment is prepared based on the extracted component information; and
a production instruction sheet output step in which the production instruction sheet prepared in said production instruction sheet preparation step is output.

12. The production management method for foundation undergarment having cups according to claim 11, wherein the component information included in said component information table consists of information regarding members, and parts produced from at least one member, that constitute the foundation undergarment.

13. The production management method for foundation undergarment having cups according to claim 11 or claim 12, wherein, in said production instruction sheet preparation step, a production instruction sheet that lists information regarding the components extracted from said component information table and instructs that said components be assembled is prepared.

14. The production management method for foundation undergarment having cups according to any of claims 11 through 13, wherein inventory information regarding each of said components is stored beforehand in inventory information storage means, and wherein, in said production instruction sheet preparation step, instructions to produce components that are out of stock are included in the production instruction sheet with reference to said inventory information storage means.

15. The production management method for foundation undergarment having cups according to any of claims 11 through 14, wherein, in said production instruction sheet preparation step, information regarding the user specified via the user identifier included in the order information is included in the production instruction sheet.

16. A computer-readable recording medium on which is recorded a program that, in order to manage the production of foundation undergarments having cups, causes the computer to function as:
user information storage means that stores information regarding user under bust size and the size of the base line of the breast as user information;
product information storage means that stores product identification information including product identifiers that are used to specify the foundation undergarment that fits a given user's under bust size and the size of the base line of the breast;
order information input means that inputs foundation undergarment order information that includes a user identifier to specify the user placing the order;
user information extraction means that extracts from the user information storage means the user information for the user specified via the user identifier included in the order information input using said order information input means; and
product determination means that determines based on the user information extracted by said user information extraction means and the product information stored in said product information table the foundation undergarment to be produced, and outputs the product identifier for the foundation undergarment.
